(19) United States
(12) Patent Application Publication
(10) Pub. No.: US 2011/0116100 A1
(43) Pub. Date: May 19, 2011

(54) SYSTEM FOR ALIGNING A MEASURED OBJECT RELATIVE TO A DETECTOR, INTERFEROMETRIC SYSTEM AS WELL AS ALIGNMENT METHOD

(75) Inventor: Matthias Fleischer, Ostfildern (DE)

(73) Assignee: ROBERT BOSCH GMBH, Stuttgart (DE)

(21) Appl. No.: 12/736,657

(22) PCT Filed: Apr. 1, 2009
(86) PCT No.: PCT/EP2009/053877

§ 371 Date: Feb. 8, 2011

(30) Foreign Application Priority Data
Apr. 30, 2008 (DE) 10 2008 001 476.1

(51) Int. Cl. G01B 11/02; G01N 21/01

(52) U.S. Cl. 356/497; 356/244; 356/496

(57) ABSTRACT

The invention relates to an arrangement for aligning a measured object (2) with a detector (5), said arrangement comprising illumination means (10) producing an illumination beam path (15) and used to illuminate the object (2) to be measured, and adjusting means (8) used to adjust the position of the object (2) to be measured in relation to the detector (5). According to the invention, the illumination means (10) comprise at least two individually controllable partial illumination means (12, 13).

### BACKGROUND OF THE INVENTION

1. Field of the Invention

The present invention relates to a system for aligning a measured object relative to a detector, to an interferometric system, and to a method for aligning a measured object relative to a detector.

2. Description of Related Art

Interferometers are employed for the precise measuring of measured objects, particularly objects having planar surfaces. Since the maximally permitted measurable angular range of the surface is limited, the measured objects must first be aligned in the angular position relative to the detector. In particular in the case of interferometers operating on the basis of short coherent light, such as white light interferometers, which have low maximum measuring depth, minimal angular deviations may then make it impossible to perform the actual interferometric measurement.

For the alignment of the measured object relative to the detector it is known to perform interferometric partial measurements and to manually align the measured object based on the image on the detector. However, in order to obtain an interference pattern on the detector at least in subregions, this requires the measured object to be already aligned relative to the detector in sufficiently precise manner. This rough alignment is left up to the user, who will use the brightness impression (light intensity) of the detector image (camera image) in his attempt to determine a satisfactory alignment position.

In addition, automatic alignment systems are known, which perform a mechanical angle scan of the measured object. In so doing, the position of the measured object relative to the detector at which the greatest light intensity is determined in the detector image is adjusted. The described procedure has the disadvantage that in the range of the maximum light intensity, the light intensity no longer changes to any significant degree with the angular position of the measured object, so that a highly precise alignment of the measured object relative to the detector is difficult to realize.

### SUMMARY OF THE INVENTION

Therefore, the present invention is based on the objective of providing a system for aligning a measured object relative to a detector, which allows an uncomplicated, exceptionally precise alignment of the measured object with regard to its angular position relative to the detector. Similarly, the objective is to provide an interferometric system having a correspondingly improved alignment system. Furthermore, the objective is to provide an alignment method which is optimized with regard to an improved alignment precision.

The framework of the present invention includes all combinations of at least two of the features disclosed in the specification, the claims and/or the figures. In order to avoid repetitions, features disclosed in terms of the device shall also count as disclosed and be claimable in terms of the method. Likewise, features disclosed in terms of the method shall count as disclosed and be claimable in terms of the device.

The present invention is based on the idea of shifting the manual evaluation of the light intensity or the automatic measurement of the light intensity away from the illumination maximum, to the flanks of an illumination intensity characteristic via the angular position of the measured object relative to the detector, so that even minimal angular changes already produce significant changes in the light intensity, detectable in the detector image, of the light beams impinging on the detector and reflected by the measured object. In a system for aligning the angular position of a measured object relative to a detector designed according to the concept of the present invention, this is achieved by providing not a single illumination means, but rather at least two (partial) illumination means which are able to be triggered separately. In the case of a measured object that is not exactly aligned relative to the detector, the light intensity of the light beams impinging on the detector and reflected by the measured object is dependent on which one of the partial illumination means happens to be triggered, i.e., active, just then. This is due to the fact that the partial illumination means illuminate different subareas of the surface of the measured object; when the measured object is illuminated by a first partial illumination means, for instance, a greater portion of light beams therefore radiates past the detector than when the measured object is illuminated by a second partial illumination means. In the ideal case, i.e., when a measured object is accurately aligned in its angular position relative to the detector, the light intensity of the light beams impinging on the detector and reflected by the measured object remains constant, regardless of which one of the partial illumination means is triggered, or the light intensities are in a defined proportion relative to each other. This may be used as an indicator of the alignment quality or as a measure of the required manual or automatic adjustment, particularly tilting, of the measured object relative to the detector. Put another way, the measured object is able to be adjusted relative to the detector until the light intensity at the detector, preferably determined with the aid of the detector, i.e., the brightness impression of the detector image, remains at least approximately constant, irrespective of which partial illumination means is being triggered, or until a particular intensity ratio has come about. The detector is preferably provided with a digital camera, in particular a CCD chip. In this context it is especially preferred if the camera chip (light-sensitive sensor) is assigned an aperture diaphragm that is situated in the beam path of the light reflected by the measured object, between the camera chip and the measured object.

Especially preferred is a specific development of the alignment system in which a so-called Kohler illumination system is realized and the partial illumination means are situated in a diaphragm plane of the lens or the lens system for parallelizing the light emitted by the partial illumination means.

In a further development of the present invention, each of the illumination means advantageously includes at least one LED. For example, the illumination means include a chip having four LEDs. When two LEDs are triggered jointly, this chip may form two partial illumination means. If a separate trigger possibility of the individual LEDs is implemented, then four partial illumination means may be realized with the aid of such a four-LED chip.

Especially preferred is a specific embodiment in which the partial illumination means are symmetrically disposed with respect to an optical axis of the lens or the lens system. In this case the optimal angular position of the measured object relative to the detector has been achieved when the light intensity of the light beams impinging on the detector is constant, regardless of which one of the partial illumination means happens to be active just then. However, it is also possible to realize a specific embodiment in which the partial illumination means are disposed asymmetrically with respect to the optical axis of the lens or the lens system. In such a case the optimal angular position of the measured object relative to the detector is achieved when the light intensities at the detector achieved with the aid of the different partial illumination means attain a specific ratio value.

Especially preferred is a specific embodiment in which the partial illumination means are able to be triggered in alternation, preferably multiple times in succession. This makes it possible to continuously determine the light intensity ratio of the light intensities that are produced with the aid of the partial illumination means and which are able to be detected at the detector during the alignment process.

A specific embodiment of the alignment system is able to be realized in which the light intensity of the light beams impinging on the detector is evaluated manually with regard to the brightness impression of the detector image, in particular the camera image. However, especially preferred is a specific embodiment of the detector in which the light intensity of the impinging light beams is measured by the detector and preferably also displayed, such as on a screen which is connected to a position unit of the detector.

Especially preferred is a specific embodiment in which the detector is designed to produce an optical and/or acoustic indicator for the alignment quality based on the light intensities of the alternately triggered partial illumination means. For this purpose the detector, or a logic unit of the detector, preferably sets the light intensities of the different partial illumination means, which are determined in alternation, in particular, into relation with each other and indicates the ratio value in the form of a graphical indicator bar, for instance.

There are various possibilities for realizing the actuating means. For example, it is conceivable to provide manual actuating means, e.g., in the form of an adjusting screw, particularly in the form of a micrometer adjusting screw, with whose aid the angular position of the measured object is adjustable relative to the detector. In addition or as an alternative, automatically controllable actuating means such as at least one piezo actuator may be provided, which adjusts the measured object relative to the detector as a function of the light intensities of the partial illumination means determined with the aid of the detector.

Especially preferred is a specific embodiment of the alignment system in which the partial illumination means are designed to emit short coherent light. The alignment system preferably is part of a white light interferometer, it being especially preferred if the illumination means of the alignment system are the illumination means for performing the interferometric measurement. In this context it is especially preferred if all partial illumination means are triggered, i.e., active, at the same time, in order to perform the interferometric measurement.

The present invention also leads to an interferometric system for measuring a measured object. According to the present invention, the interferometric system is equipped with a system for aligning the measured object relative to the detector developed according to the concept of the present invention, in particular a digital camera.

As mentioned, it is especially preferred if the illumination means of the system for aligning the measured object relative to the detector are simultaneously the illumination means for illuminating the object during the interferometric measurement, it being especially preferred if all partial illumination means are active, i.e., triggered, during the interferometric measurement.

The present invention also leads to a method for aligning a measured object relative to a detector, preferably using a previously described alignment system. Instead of being illuminated by a single illumination means during the alignment operation, in the present invention the measured object is preferably illuminated in alternation by at least two partial illumination means, which are situated next to each other, particularly in one plane (e.g., the diaphragm plane), the relative position, in particular the angular position, of the measured object relative to the detector being modified as a function of the light intensities of the light beams generated by the partial illumination means and impinging on the detector. In an especially preferred manner, a ratio value of the light intensities generated by the various partial illumination means is determined as a measure of the alignment quality.

Especially preferred is a specific embodiment in which the relative position, particularly the angular position of the measured object relative to the detector, is modified by adjusting the measured object and/or the detector, until the ratio of the light intensities of the light beams generated by the partial illumination means and impinging on the detector has attained a defined value. In the event that the partial illumination means are disposed symmetrically with respect to an optical axis of a lens or a lens system situated in the illumination beam path, this ratio of the light intensities is 1.

There are various possibilities for evaluating the light intensities. For example, it is possible to evaluate the light intensity manually, by subjective optical perception of the brightness impression of the detector image. Especially preferred is a specific embodiment in which the light intensities of the light beams of the partial illumination means are determined with the aid of the detector, particularly with the aid of a suitable control device of the detector.

### BRIEF DESCRIPTION OF THE DRAWINGS

Additional advantages, features and details of the present invention derive from the following description of preferred exemplary embodiments as well as from the figures.

FIG. 1 shows a schematic illustration of an interferometric system for measuring a measured object, which includes a system for aligning the measured object relative to a detector.

FIG. 1b shows a view, rotated by 90°, of the illumination means of the system for aligning the measured object relative to a detector, the illumination means being made up of a plurality of partial illumination means and simultaneously serving as illumination means of the interferometric system.

### DETAILED DESCRIPTION OF THE INVENTION

Identical components and components having the same function are labeled by the same reference symbols in the figures.

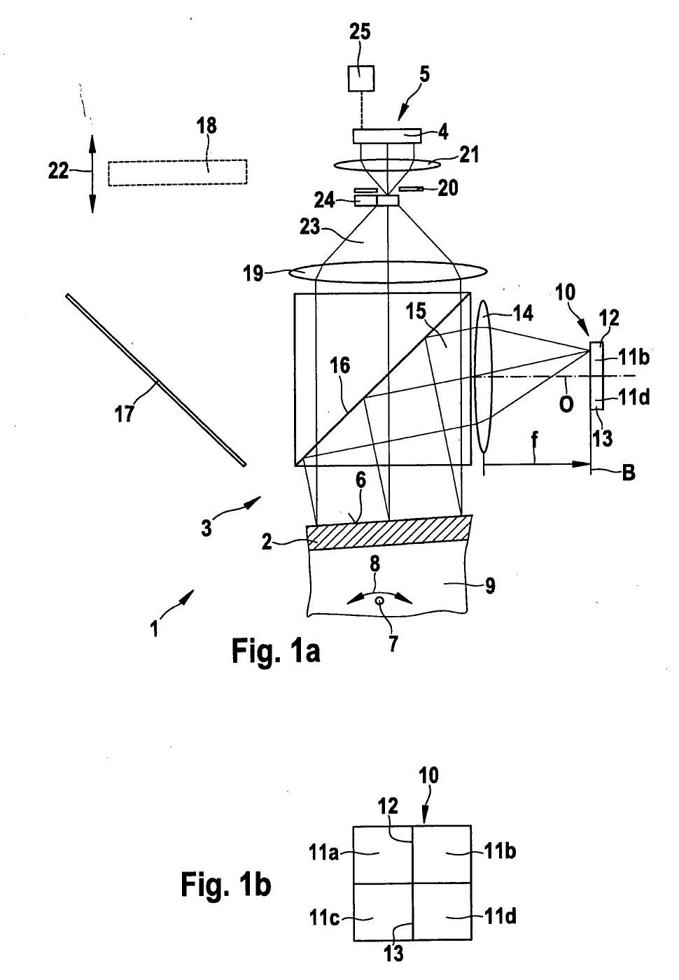

FIG. 1a shows an interferometric system 1 for measuring surfaces of a measured object 2. Interferometric system 1 being shown is an interferometer that measures surfaces, in this case, a white light interferometer.

The structure includes a system 3 for aligning the angular position of measured object 2 relative to a detector 5, which includes a CCD chip 4 of a digital camera. In order to be able to perform exact interferometric measurements of the surface of measured object 2, surface 6 of measured object 2 must be aligned parallel to the surface extension of CCD chip 4 of detector 5 in the illustrated exemplary embodiment. For tilting (swiveling) measured object 2 about an axis of rotation 7, actuating means 8 are provided, which are actuable manually or automatically depending on the embodiment and are shown merely schematically as swivel arrows. Actuating means 8 are acting on a support 9, on which measured object 2 is fixed in place.

System 3 for aligning measured object 2 relative to detector 5 includes illumination means 10. As can be gathered from FIG. 1b, these are developed in the form of a four-LED chip having four LEDs 11a, 11b, 11c, 11d. LEDs 11a, 11b disposed on top in the drawing plane, jointly form first partial illumination means 12, and LEDs 11c, 11d disposed underneath in the drawing plane, form second partial illumination means 13. This means that upper LEDs 11a, 11b and lower LEDs 11c, 11d are able to be triggered as a unit in each case. It is also possible to realize an embodiment that includes four partial illumination means; in this case each LED 11a, 11b, 11c, 11d forms an independently triggerable partial illumination means.

As can be gathered from FIG. 1a, partial illumination means 12, 13 are disposed symmetrically with respect to an optical axis O of a lens 14 of an illumination beam path 15 produced with the aid of illumination means 10. The function of lens 14 consists of parallelizing the short coherent light beams radiated by illumination means 10. Illumination means 10 are disposed in a diaphragm plane B of lens 14 extending through the focus of lens 14, partial illumination means 12, 13 being situated next to each other in diaphragm plane B, in the case at hand, one above the other.

The light beams, which have been radiated by illumination means 10 and form an illumination beam path 15, impinge on a beam splitter 16, which in the exemplary embodiment shown is formed by a semitransparent mirror, which is disposed at a 45° angle relative to optical axis O. From there, a portion of the light beams generated by illumination means 10 is directed in perpendicular fashion to surface 6 of measured object 2, from where the light beams are routed back to beam splitter 16, straight through it, through a focusing lens 19, an aperture diaphragm 20, and a lens 21, to impinge on detector 5, more precisely, CCD chip 4. In order to be able to detect interference phenomena with the aid of interferometric system 1, the (measuring beams) arriving at detector 5 from object surface 6 must have reference light beams superposed during the measuring of measured object 2. The reference light beams are split off from illumination beam path 15 with the aid of the beam splitter; these are the light beams radiated in a straight line through beam splitter 10 by illumination means 10 and not illustrated, which impinge on a mirror 17 in the process, which reflects the reference light beams to a reference element 18 formed by a reference mirror in this exemplary embodiment. From there, the reference beams are reflected back to mirror 17, and from there directed to beam splitter 16, which deflects the reference beams at a right angle in the direction of detector 5, more precisely, to CCD chip 4. Since illumination means 10 radiate only short coherent light, interference phenomena at detector 5 manifest themselves only if the difference in path between the actual measuring beams and the reference beams is less than the coherence length of the light beams, preferably zero. In order to be able to adjust this path difference, reference element 18 is linearly adjustable, as indicated by arrows 22.

In particular in the case of illumination means 10 emitting short coherent light exclusively, the previously described measuring of measured object 2 is able to be carried out only if measured object 2 is aligned relative to detector 5, in this case, aligned parallel to the surface extension of CCD chip 4 of detector 5. In such an aligned case, imaging beam path 23 (combined measuring and reference beam path) results, which is designated by reference numeral 23.

For an alignment of measured object 2 relative to detector 5, partial illumination means 12, 13 are triggered in alternation. If measured object 2 is precisely aligned relative to detector 5, then the light intensity (brightness impression) of the detector image (camera image) remains constant, regardless of which particular partial illumination, means 12, 13 happens to be triggered, i.e., active, just then. If measured object 2 is not precisely aligned in its angular position relative to detector 5, as in the case at hand, the light intensity able to be detected at detector 5 changes as a function of the particular partial illumination means 12, 13 that are triggered, i.e., active, at this particular point in time. FIG. 1a shows that only partial illumination means 12, which are on top in the drawing plane, are triggered. As can additionally be gathered from the illustration according to FIG. 1, not all of the light beams emitted by partial illumination means 12 and reflected by measured object 2, more precisely, by surface 6, and radiating through beam splitter 16 impinge on CCD chip 4, but instead are held back by aperture diaphragm 20, as indicated by reference numeral 24, which designates a subimage detail of the image of illumination means 10. The light intensity of the light beams impinging on CCD chip 4 is determined with the aid of detector 5, evaluated in a logic unit 25 (control device of detector 5), and buffer-stored. As an alternative, a subjective evaluation of the brightness of the detector image is possible. Then, partial illumination means 12 are deactivated and partial illumination means 13 triggered instead, which causes a change in the light intensity to be determined at detector 5. In the exemplary embodiment shown, the light intensity increases because a smaller portion of the light beams generated by partial illumination means 13 and reflected at surface 6 of measured object 2 is deflected such that it no longer impinges on detector 5. Logic means 25 determines this light intensity and sets the most recently measured light intensity in relation to the buffer-stored, previously measured light intensity. Depending on how high the ratio value is, measured object 2 must be tilted about axis of rotation 7 with the aid of actuating means 8, manually or automatically, either in the one or in the other direction. An optimal alignment is obtained when the ratio value is 1 in the exemplary embodiment shown, i.e., the light intensity remains unchanged regardless of which partial illumination means 12, 13 happen to be activated just then.

To implement the initially described, actual interferometric measuring of surface 6 of measured object 2, all partial illumination means 12, 13 of illumination means 10 are triggered in order to realize the greatest possible light yield.

1-14. (canceled)

15. A system for aligning a measured object relative to a detector, comprising: illumination means, which produce an illumination beam path, for illuminating the measured object, the illumination means having at least two individually triggerable partial illumination means, and actuating means for adjusting the relative position of the measured object relative to the detector.

16. The system as recited in claim 15, wherein the partial illumination means are disposed next to each other in a diaphragm plane of a lens or a lens system situated in the illumination beam path.

17. The system as recited in claim 15, wherein each of the partial illumination means include at least one LED.

18. The system as recited in claim 16, wherein each of the partial illumination means include at least one LED.

19. The system as recited in claim 16, wherein the partial illumination means are disposed symmetrically to an optical axis of the lens or the lens system.

20. The system as recited in claim 17, wherein the partial illumination means are disposed symmetrically to an optical axis of the lens or the lens system.

21. The system as recited in claim 15, wherein the partial illumination means are able to be triggered in alternation.

22. The system as recited in claim 16, wherein the partial illumination means are able to be triggered in alternation.

23. The system as recited in claim 15, wherein the detector determines light intensities of light beams reflected at the measured object, generated by the partial illumination means and impinging on the detector.

24. The system as recited in claim 16, wherein the detector determines light intensities of light beams reflected at the measured object, generated by the partial illumination means and impinging on the detector.

25. The system as recited in claim 23, wherein the detector generates at least one of an optical indicator and acoustic indicator for the quality of alignment based on the light intensities of the light beams of the partial illumination means triggered in alternation.

26. The system as recited in claim 15, wherein the actuating means are able to be actuated manually.

27. The system as recited in claim 15, wherein the actuating means are able to be actuated automatically, as a function of light intensities of the light beams of the partial illumination means determined with the aid of the detector.

28. The system as recited in claim 15, wherein the partial illumination means are designed to emit short coherent light.

29. An interferometric system for measuring a measured object and having a system for aligning the measured object relative to a detector as recited in claim 15.

30. The interferometric system as recited in claim 29, wherein the illumination means of the system for aligning the measured object relative to the detector are the illumination means for illuminating the object during the interferometric measurement.

31. The interferometric system as recited in claim 30, wherein the illumination means emits short coherent light.

32. A method for aligning a measured object relative to a detector, comprising: illuminating the measured object with illumination means, and modifying a relative position of the measured object to the detector as a function of light intensity of light beams reflected at the measured object, generated by the illumination means and impinging on the detector, wherein the measured object is illuminated with at least two partial illumination means, and the relative position of the measured object to the detector is modified as a function of the light intensities of the light beams generated by the partial illumination means, reflected at the measured object, and impinging on the detector.

33. The method according to claim 32, wherein the measured object is illuminated in alternation.

34. The method as recited in claim 33, wherein the relative position is modified until the ratio of the light intensities impinging on the detector and generated with the partial illumination means has at least approximately attained a specific value.

35. The method according to claim 34, wherein the specific value is one.

36. The method as recited in claim 34, wherein the light intensities of the light beams of the partial illumination means impinging on the detector are determined automatically with the aid of the detector.
